(19) United States
(12) Patent Application Publication
(10) Pub. No.: US 2010/0072755 A1
(43) Pub. Date: Mar. 25, 2010

(54) Conversion of permanent magnetic field into constant rotary motion

(76) Inventors: Hieronim Zmarlicki, South Windsor, CT (US); Michal Zmarlicki, New Britaiin, CT (US)

Correspondence Address: Hieronim Zmarlicki, 62 Berry Patch, South Windsor, CT, 06074, US

(21) Appl. No.: 12/217,658

(22) Filed: Sep. 24, 2008

(51) Int. Cl. F03D 9/00

(52) U.S. Cl. 290/55

(57) ABSTRACT

During the long ages, human race have many occasions to contact with two “INVISIBLE ENERGIES”.

One of said above “Invisible Energies”—is “BLOWING WIND”, which creates invisible, unidirectional “PUSHING POWER”.

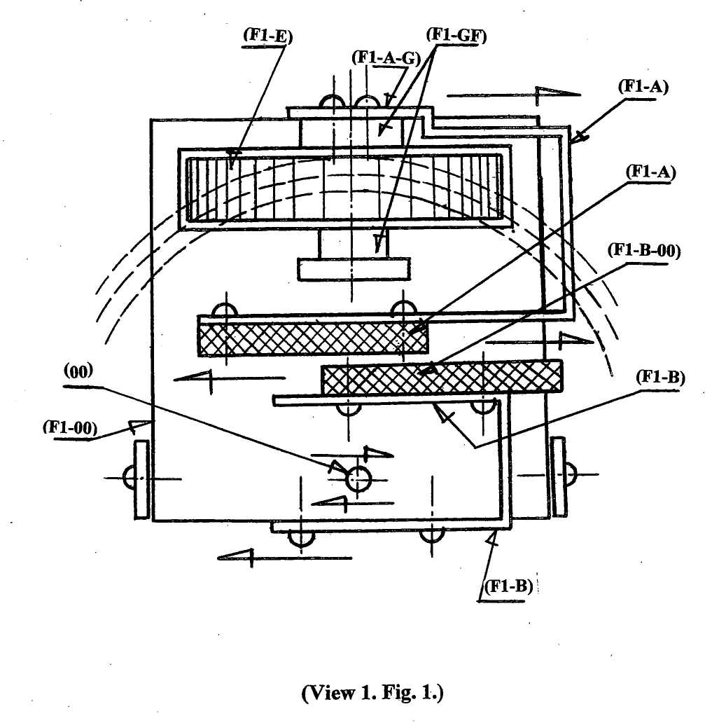

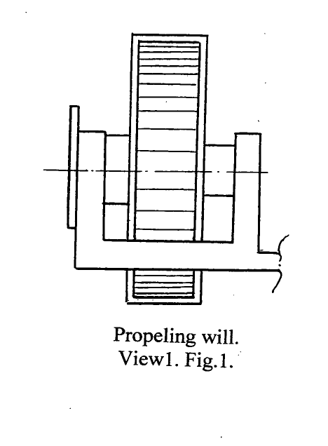

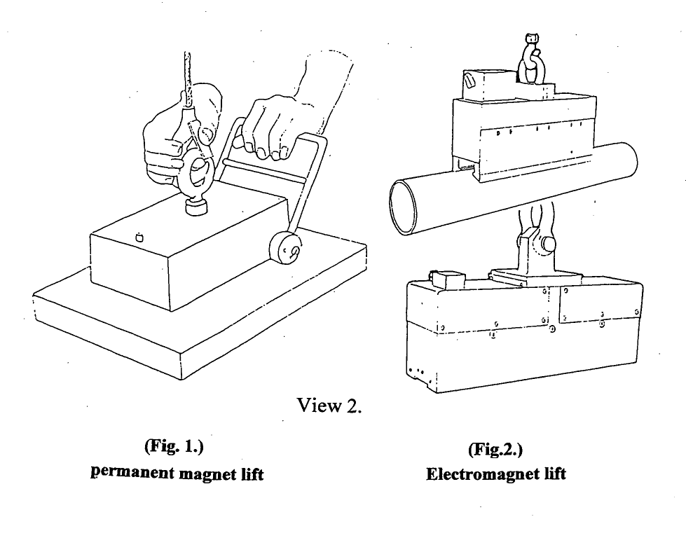

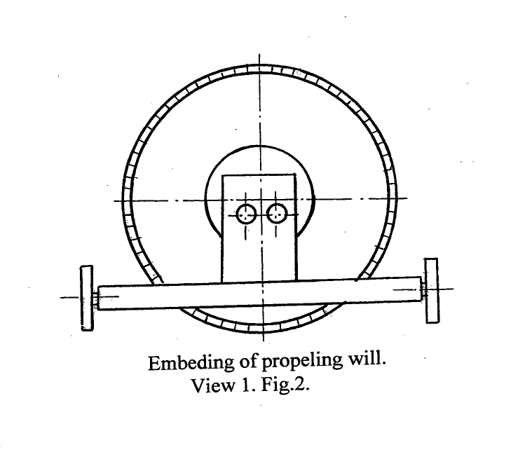

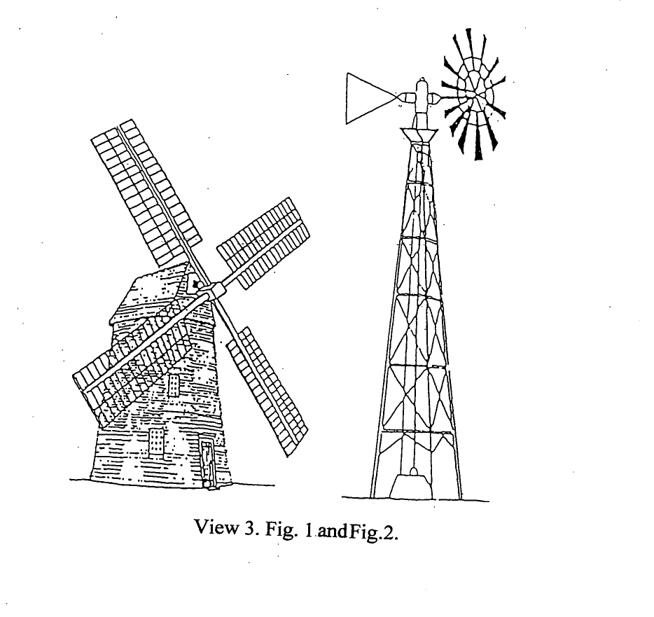

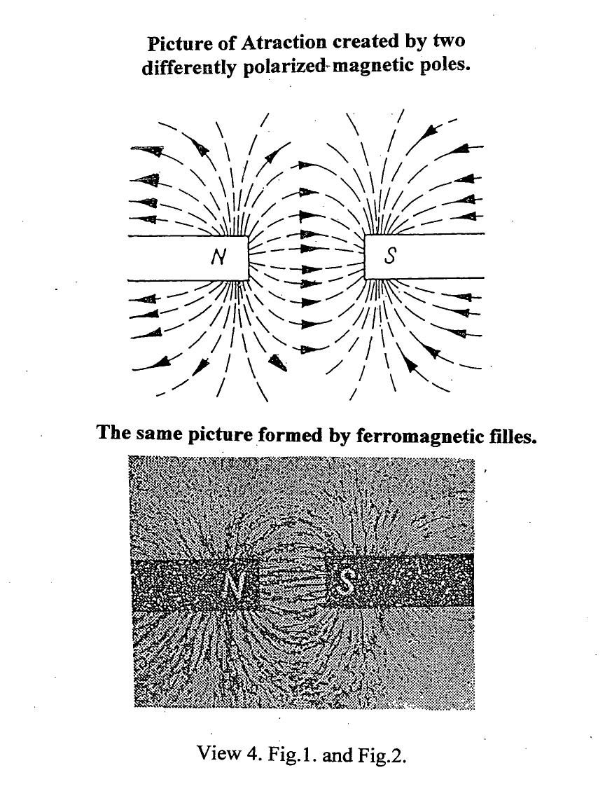

Mentioned above unidirectional “Pushing Power” of blowing wind—strikes oblique shaped vanes of turbine, and slides on sloped shape of vanes—is immediately transformed into “ROTARY MOTION”. (View 2 FIGS. 1-2).

Said above “Rotary Motion”, is used to perform many expensive jobs as example: (Pumping water for cattles on extensive pastures, producing flour from grains, and creation electricity-free pollution). (See View 2—FIGS. 1-2).

Possibility of transforming an unidirectional winds “PUSHING POWER” into “Rotary Motion”, encouraged us to sacrifice many years of strenuous experiments and researches—to create similar transformation of Unidirectional “Magnetic Pushing Power”—into “Constant Rotary Motion”.

At last—our intensive experiments and researches—on May 22, 2006—became crowned with true success, and on a May 27, 2006—our application was registered by United States Patent and Trademark Office under #602765.

### FIELD OF THE INVENTION

The invention relates to “CONVERSION OF PERMANENT MAGNETIC FIELD INTO CONSTANT ROTARY MOTION”—expresses themselves a special magnetic mechanism which rotate similarly like any car engine, electric motor, or windmill.

Specific application of the magnetic rotary mechanism is appropriated to utilize its rotary power—to to produce a free electricity. Said above “Free Electricity” can be supplied to various home appliances, and entirely to reduce high electric power expenses.

Mentioned above Permanent Magnetic Rotary Mechanism, may be constructed by any skilled in the mechanical art person. Such constructed magnetic rotary mechanism, can fulfil all said above functions and assignment.

### BACKGROUND OF THE INVENTION

The prior art includes a wide variety of rotary mechanisms such as windmills, steam machines, car engines or electric motors. Up to this time nobody offered people permanent magnet rotary mechanism.

Said above rotary mechanisms—was propelled by various energies like: blowing wind, fire producing steam, petroleum or electric power.

Our invention offers people rotary mechanism propelled by magnetic energy of permanent magnet.

Offered by us magnetic rotary mechanism—can rotate continuously, using only energy existing in “PERMANENT MAGNET”

Magnetic Energy is free and cost nothing. This truth shows (View 2 FIG. 1-2), where the same jobs performs expensive electromagnetic lift, and free-permanent magnet lift.

“Conversion of Permanent Field into Constant Rotary Motion” and its Continuous Rotation, entirely conforms to the “Law of Conservation of Energy”, because not creates energy from nothing, but only Convert Existing Energy in Permanent Magnet into Constant Rotary Motion.

Due to this—invented by us magnetic mechanism continuously rotating—never can be called “Perpetual Motion”.

The Law of Conservation of Energy expresses IMPOSSIBILITY Creation Energy from nothing.

The “Law of Conservation of Energy” states—that “ENERGY” not erises sel-acting from nothing, and does not disappear without trace.

Said above “Law of Conservation of Energy” admits only to transform existing energy from one form into another.

Our invention proves, that we honor all establishment of mentioned above “LAW” and presents to U.S. Patent and Trademark Office—newly invented practical system of transformation magnetic energy existing in permanent magnet, and how to use them. (See View 1 FIG. 1).

### SUMMARY OF THE INVENTION

It is an object of the invention to provide a simple and inexpensive Rotary Magnetic Mechanism, which is able continuously produce electric energy, and supply them for the all home needs.

A further object of present invention is to improve, that said above “ROTARY MAGNETIC MECHANISM” is able to supply such Quantity of Electric Energy which satisfy the needs of all home appliances.

So more, mentioned above Rotary Magnetic Mechanism—is propelled by “Permanent Magnetic Energy”, which cost nothing.

It has been found now—that these and another objects of the invention became possible to achieve oving discovered in Greece lodestone which attracted iron. Discoverer is unknown.

Through over two thousand years discovered magnetic mineral remained mere as a curiosity.

Then at some time in the early middle ages someone discovered that a piece of mineral called “lodestone” floating in water, always set in one particular geographic direction.

This fact was used in navigation for indication direction at sea. The inventor of compass is not known. Probably it is originated in China. Chinese writer Chu Yu noticed, that sailors were employing it on the ships Sailing between Canton and Sumara.

An English monk from St. Albans—Alexander Neckam (1157-1217)—was very familiar with the compass but he does not claim it to be a new invention.

In 1269 Petrus Peregrinus a French crusader gave the first detailed description of the floating compass. After this time little progress was made until the work of William Gilbert native of Colchester (1540-1603).

Gilbert extended the observations of Peregrinus and explained the fact that magnets always take up one particular orientation in any point on the earth's surface.

He realized that the earth is itself one huge magnet with its magnetic poles situated near the geographic NORTH and SOUTH poles.

Precisely—the LOW OF FORCE BETWEEN MAGNETIC POLES had been discovered and described by John Mitchell in 1750 at Cambridge. (1724-1793). Later was confirmed by Columb—Both for attraction between unlike poles—and the repulsion between like poles.

### BRIEF DESCRIPTION OF THE DRAWING

The invention of the “Conversion of Permanent Magnetic Fields into Constant Rotary Motion” will be better understood with accompanying drawings in which:

1. General view of the invention is presented on a title page.

2. General view of the invention (Top View #1. FIG. 1.)—shows arrangement of each part of said invention.

3. Transformation of the “Unidirectional Pushing Power” created by the “Blowing Wind” into “Rotary Motion” is presented on (View #3. FIG. 1-2.)

4. The “FACT” of “Free Magnetic Energy”, which is supplied by “Permanent Magnet”—proves (View #2. FIGS. 1-2.)

5. “Magnetic Properties”—especially magnetic lines—are presented on (View. #4. FIGS. 1-2).

6. “AN ATTRACTION” of two differently polarized magnetic poles—are presented on (View #.4. FIGS. 1-2).

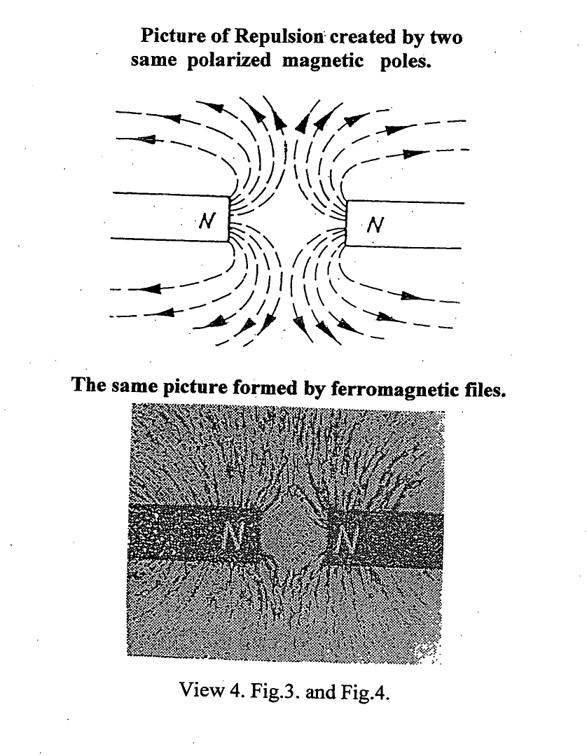

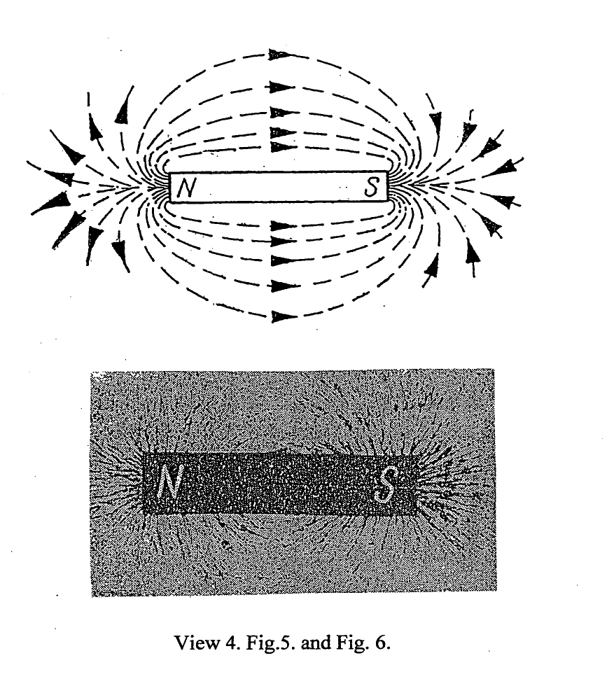

7. “The REPULSION” of two same polarized magnetic poles—are presented on (View #4. FIGS. 3-4).

### DETAILED DESCRIPTION OF PREFERRED EMBODIMENTS

Referring now to “Top View” of Magnetic Rotary Mechanism—(View #.1 FIG. 1), and arrangement comprises each part of said above “Magnetic Rotary Mechanism on small base of Model—(FIG. 1. 0-0)—we specify everything on them.
1. Said above small base of entire Model of mentioned above Magnetic Rotary Mechanism—(FIG. 1. 0-0) —shows small aluminum plate having long rectangle hole, in which is settled aluminum will (FIG. 1.-G-F).
2. Said above aluminum propelling will—is mounted on two embeddings (FIG. 1. G-F).
3. One end of the first brace (FIG. 1.A)—is fastened to the embedding (FIG. 1.G).
4. First end of the second brace (FIG. 1. B)—is fastened on the opposite side of small base (FIG. 1.00), and second end of brace (FIG. 1. B)—is connected with “Permanent Magnet” (FIG. 1 B).
5. Poles “N” and “S” of “Permanent Magnets” (FIG. 1. A)—are shifted by half of its length—against poles “N” and “S” of second “Permanent Magnet” (FIG. 1. B). Such located “Permanent Magnets”—due to their properties—attract themselves and automatically pull braces “A” and “B” in opposite directions.
6. An activity of such settled magnets—creates continuous rotation of presented model.
7. (View 4. FIGS. 1. and 2.)—shows “Permanent Magnets Lines”—from Pole “N” to “S”. Every “Permanent Magnet” regardless its shape—posesses two unlike poles: One “Negative” “N”—North, and second “Positive” “S”—South.
8. The thickness of Magnetic “Flux”—depends on entire magnetic size—means “Magnetic Mass” of its body.
9. The magnetic “Flux” characterizes tendency to maximal reduction the length of its magnetic lines.
10. On of the Magnetic Poles—characterizes “ATTRACTION”, and another one—“REPULSION”.
11. The Poles, which have the same polarity—characterizes “REPULSION”, and Poles having different polarity characterizes “ATTRACTION”.
12. The power of magnetics—“ATTRACTION” and “REPULSION”—depend on tickness of magnetic “FLUX”, its length and distance which exist between both magnetic poles. The “LOW” of the force—means Magnetic Power “F”, which is proportional to square of their distance apart, and strength of each poles.

$$F = \frac{M 1 \times M 2}{d 2}$$

What is claimed is:

1. The entire “TITLE” of our invention called: “CONVERSION OF PERMANENT MAGNETIC FIELD INTO CONSTANT ROTARY MOTION”, because said above “TITLE” comprises whole “ART” of activity—of said above invention.

2. View of invention #1—FIG. 1—shows the basic “ART” of activity of our invention.

3. The middle point of cited above View 1. FIG. 1. shows two oblong permanent magnets fastened to special braces.

4. The opposite “ENDS” of said braces, are fixed with two opposite sides of our model and opposite to main axle.

5. Two opposite “POLES” of of two permanent magnets, are shifted one to another, by the half of their length. So “N” pole of the first permanent magnet, is placed in a centre of second magnet—means between “N” and “S” poles of second Magnet.

6. Such location of the permanent magnets, assure continuous pushing on fastened braces—each of them in opposite direction and creates permanent rotation of entire working model. (See General View—FIG. 1).

7. The lower part of working model called “BASE”, is not shown on General View FIG. 1. Base performs only auxiliary, however important function, because “main axle” of working model—is bedded in said base. Main axle is connected by gear with electric generator, which continuously produces electricity.
